(19) United States
(12) Patent Application Publication
(10) Pub. No.: US 2007/0000738 A1
(43) Pub. Date: Jan. 4, 2007

(54) Vehicle braking system

(76) Inventors: Dietmar Baumann, Hemmingen (DE); Dirk Hofmann, Ludwigsburg (DE); Herbert Vollert, Vaihingen/Enz (DE); Willi Nagel, Remseck/Hochdorf (DE); Andreas Henke, Diemelstadt (DE); Bertram Foitzik, Ludwigsburg (DE); Bernd Goetzelmann, Moeglingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/556,595

(22) PCT Filed: Jul. 1, 2004
(86) PCT No.: PCT/DE04/01384

§ 371 Date: Nov. 14, 2005

(30) Foreign Application Priority Data
Aug. 21, 2003 (DE) 103 38 449.9

(51) Int. Cl. F16D 55/46

(52) U.S. Cl. 188/72.2

(57) ABSTRACT

A vehicle brake system having self-amplifying electromechanical wheel brakes have a self-amplification devices that are effective in only one rotation direction of the vehicle wheels and therefore in only one travel direction. The self-amplification devices of the wheel brakes associated with a front axle are effective in the forward travel direction and the self-amplification devices of the wheel brakes associated with a rear axle are effective, for example, in the reverse travel direction.

### PRIOR ART

The present invention relates to a vehicle brake system with the characterizing features of the preamble to claim 1. The vehicle brake system is particularly provided for motor vehicles such as passenger and commercial vehicles.

Self-amplifying electromechanical wheel brakes are known. For example, DE 101 51 950 A1 has disclosed a brake of this kind embodied in the form of a disc brake. In order to apply pressure to a friction brake lining, the known wheel brake has an electromechanical actuating device with an electric motor and a screw link actuator functioning as a rotation/translation converting transmission that is able to move the friction brake lining and thus press it against a brake disc. The friction brake lining is situated in a disc brake caliper, which is embodied in a known manner as a so-called floating caliper, i.e. it can move transversely in relation to the brake disc. When the one friction brake lining is pressed against the brake disc, a second friction brake lining situated on the opposite side of the brake disc from the one friction brake lining in the disc brake caliper is pressed in an intrinsically known manner against the other side of the brake disc through a transverse movement of the disc brake caliper. Other designs of electromechanical actuating devices are also known.

For self-amplification purposes, the known friction brake has a wedge mechanism with a wedge, which is situated on a back side of the one friction brake lining oriented away from the brake disc and rests against an inclined surface in the disc brake caliper that is inclined in relation to the brake disc at an angle that corresponds to the wedge angle. In order to actuate the brake, the electromechanical actuating device slides the friction brake lining in a rotation direction of the brake disc, which rotates in the direction of a narrowing wedge gap between the inclined surface and the disc brake caliper. The friction brake lining moves toward the brake disc obliquely at the wedge angle and is pressed against the brake disc. A friction force exerted on the friction brake lining by the rotating brake disc acts on the friction brake lining in the direction of the narrowing wedge gap between the inclined surface of the disc brake caliper and the brake disc. Because the friction brake lining is supported against the inclined surface by the wedge, the so-called wedge principle causes the inclined surface to exert a supporting force on the wedge, which force has a force component extending transversely in relation to the brake disc. This force component transverse to the brake disc represents a pressing force that presses the friction brake lining against the brake disc in addition to a force exerted by the actuating device and thus increases the braking force. Consequently, only a part of the pressing force required for braking is exerted by the actuating device; the remaining pressing force is generated by the self-amplification device.

In lieu of a wedge mechanism, it is also possible, for example, to provide a lever mechanism with a lever that supports the friction brake lining at an angle oblique to the brake disc during braking. A support angle of the lever here corresponds to a wedge angle of the wedge mechanism. In addition to mechanical self-amplification devices, hydraulic self-amplification devices, for example, are also known. Moreover, the present invention is not limited to wheel brakes in the form of disc brakes; other brake designs can also be used.

A self-amplifying factor in a wedge mechanism is constant, assuming that the friction value is constant. By using a ramp instead of a wedge, with a ramp angle that changes over the course of the ramp, the self-amplification can be changed as a function of a movement path of the friction brake lining and therefore as a function of an actuating force, pressing force, and braking force. For example, a large ramp angle at the beginning of the ramp achieves a rapid application at the beginning of an actuation of the wheel brake and a small ramp angle at the end of the ramp achieves a powerful self-amplification with a powerful pressing and braking force.

EP 953 785 A2 has disclosed another self-amplifying electromechanical wheel brake. Whereas the above-explained wheel brake is embodied in the form of a partially lined disc brake, the above-cited EP 953 785 A2 discloses a fully lined disc brake with a lining support ring that is situated coaxial to a brake disc on the one side and supports the friction brake lining on its side oriented toward the brake disc. On a side oriented away from the brake disc, the lining support ring has wedge elements that are supported on rotating rollers, which are in turn supported in stationary fashion. Rotation of the lining support ring causes the wedge elements to come into contact with the rollers, which moves the lining support ring in the direction of the brake disc and presses the friction brake linings against the brake disc. Here, too, the above-described self-amplification occurs due to the wedge principle. The wedge elements have opposing inclined wedge surfaces so that with an opposite rotation direction of the brake disc, the lining support ring is also rotated in the opposite direction, i.e. once again in the rotation direction of the brake disc.

Self-amplifying electromechanical wheel brakes in actual use always have a self-amplification device for one rotation direction and another self-amplification device for the other rotation direction, i.e. for example two opposing inclined wedge elements, in order to have a self-amplifying action for travel in both the forward and reverse directions. The wedge angle and therefore the self-amplification can be the same or different for travel in the forward and reverse directions. Self-amplification devices for both rotation directions have the disadvantage that they make the wheel brake more complex in design and therefore more expensive. Another disadvantage is that in order to actuate the wheel brake, the friction brake lining must always be slid in the rotation direction to generate the self-amplification. When the friction brake lining is moved in opposition to the rotation direction of the brake disc, if there were no second self-amplification device, there would be a self-attenuation of the pressing and braking force, i.e. the actuating device would have to exert a higher actuation force to achieve a particular pressing force of the friction brake lining against the brake disc than would be the case without a self-amplification device. This is the reason why only wheel brakes with self-amplification in both rotation directions of the brake disc are considered for practical use in motor vehicles.

### ADVANTAGES OF THE INVENTION

The vehicle brake system according to the present invention, with the characterizing features of claim 1, has self-amplifying electromechanical wheel brakes associated with the vehicle wheels. According to the present invention, all or at least part of the wheel brakes have a self-amplification for only one travel direction. Basically, the vehicle brake system can also be embodied in the form of a so-called hybrid brake system in which only part of the wheel brakes are actuated electromechanically and other wheel brakes are actuated hydraulically or are actuated in some other way that is not electromechanical.

The present invention has the advantage that using electromechanical wheel brakes with self-amplification in only one rotation direction, at least for a part of the wheel brakes, means using wheel brakes that are structurally simpler and therefore less expensive to manufacture. The vehicle brake system is thus more reasonably priced. Another advantage of the present invention is that wheel brakes with self-amplification in only one rotation direction do not require any detection of rotation or direction or travel direction for brake actuation since the friction brake lining is always moved in the same direction for actuation. An additional advantage of the present invention is a simple possibility for wear adjustment. When the wheel brakes are released, the friction brake lining is retracted until a desired clearance is produced, i.e. a desired gap between the friction brake lining and the brake disc. As the friction brake lining wears down, the friction brake lining is thus not retracted into its original starting position before the friction brake lining became worn. An actuation distance for bridging the clearance is thus independent of the wear on the friction brake lining and is thus always constant. A self-attenuation in the opposite rotation direction is accepted in the vehicle brake system according to the present invention. It is acceptable because for example when traveling in reverse, the occurrence of dynamic axle load shift means that it is sufficient to exert a comparatively less powerful braking force in the front axle. It should be recalled at this juncture that the wheel brakes must be designed for maximum speed when traveling in the forward direction, which is why a significantly less powerful braking force is entirely sufficient for travel in the reverse direction, which occurs at only a small fraction of the maximum speed when traveling in the forward direction.

According to claim 1, wheel brakes associated with a front axle of a vehicle have a self-amplification that is effective only in the forward travel direction. Consequently, the wheel brakes that must exert the most powerful braking force, in passenger vehicles in any case, have a self-amplification only in the forward travel direction.

In order to achieve a self-amplification for travel in the reverse direction as well, according to claim 2, wheel brakes associated with a rear axle have a self-amplification that is effective only in the reverse travel direction.

By contrast, according to claim 3, wheel brakes associated with the rear axle, like the wheel brakes associated with the front axle, have a self-amplification that is effective only in the forward travel direction. In this embodiment form of the present invention, more importance is placed on a powerful braking force in both vehicle axles in the forward travel direction since that is when the most powerful braking forces are needed. Despite the self-attenuation of the wheel brakes when traveling in reverse, the braking force is sufficient for this travel direction.

According to claim 4, wheel brakes associated with a rear axle have self-amplification devices that are effective in both directions of travel. In this embodiment form of the invention, wheel brakes are used for the rear axle that have a self-amplification in both travel directions, as is usually the case in wheel brakes currently in use. As a result, at least the wheel brakes of one axle have a self-amplifying action when traveling in the reverse direction as well. It is necessary, though, to accept the use of wheel brakes that are more structurally complex and more expensive.

In the embodiment according to claim 5, wheel brakes associated with a rear axle are not equipped with any self-amplification device. As a result, the braking force of the wheel brakes of the rear axle here is independent of the direction in which the vehicle is traveling. Because they are not equipped with a self-amplification device, these wheel brakes are structurally simpler and therefore less expensive.

According to independent claim 8, electromechanical wheel brakes associated with a front axle have a self-amplification that is effective in both directions of travel and wheel brakes associated with a rear axle have a self-amplification that is effective in only one travel direction. This embodiment of the invention, too, has a self-amplification that is effective when traveling in reverse in one vehicle axle, in this case the front axle. For the rear axle, structurally simpler and less expensive wheel brakes are used. If need be, the wheel brakes associated with the rear axle can also be embodied without a self-amplification device.

### DRAWINGS

The present invention will be explained in detail below in conjunction with exemplary embodiments shown in the drawings. The drawings are understood to be simplified schematic representations.

FIG. 1 shows a self-amplifying electromechanical disc brake; and

FIGS. 2 to 6 show possible arrangements of self-amplifying electromechanical wheel brakes on the front and rear axle of a motor vehicle according to the present invention.

### DESCRIPTION OF THE EXEMPLARY EMBODIMENTS

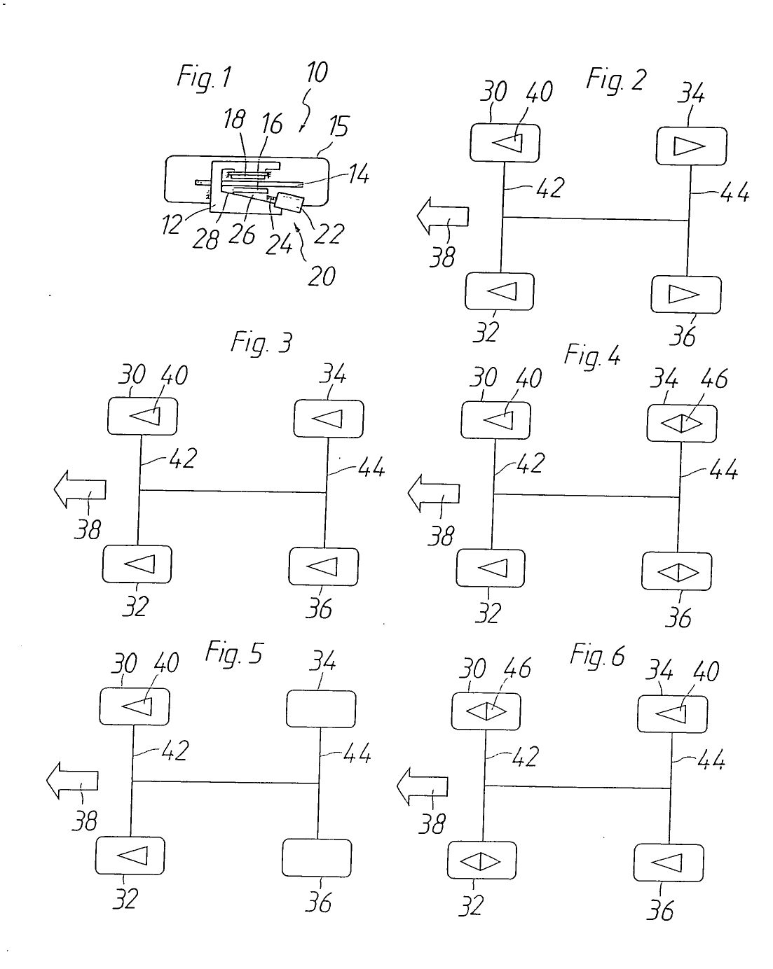

The wheel brake according to the present invention shown in FIG. 1 is embodied in the form of a disc brake 10. It has a floating caliper 12 that can move transversely in relation to the brake disc 14. The brake disc 14 is attached to a vehicle wheel 15 so that it cannot rotate in relation to the wheel. The disc brake caliper 12 contains two friction brake linings 16, 18, one on each side of the brake disc 14; an electromechanical actuating device 20 can slide the one brake lining 16 in a circumference or rotation direction of the brake disc 14 to execute a braking maneuver and the other brake lining 18 is affixed in stationary fashion in the disc brake caliper 12. The actuating device 20 has an electric motor 22 that can slide the friction brake lining 16 by means of a screw link actuator 24. The friction brake lining 16 is supported by means of a wedge 26 on an inclined surface 28 of the disc brake caliper 12 and can be slid along the inclined surface 28 by means of the actuating device 20.

To execute a braking maneuver, the actuating device 20 slides the friction brake lining 16 along the inclined surface 28 in the direction of a narrowing wedge gap between the inclined surface 28 and the brake disc 14. The friction brake lining 16 thus moves toward the brake disc 14 and is pressed against it. In the course of this, the brake-disc caliper 12 is slid in an intrinsically known way, transversely in relation to the brake disc 14 and presses the other friction brake lining 18 against the other side of the brake disc 14, which is braked as a result. The brake disc 14 acts on the two friction brake linings 16, 18 with a friction force oriented in the rotation direction of the brake disc 14. If the brake disc 14 is rotating in the direction of the narrowing wedge gap between the inclined surface 28 and the brake disc 14, then the friction force that the rotating brake disc 14 exerts on the sliding friction brake lining 16 being pressed against it, due to the support on the inclined surface 28, exerts a force with a component extending transversely in relation to the brake disc 14 as a result of the so-called wedge principle. This force presses the friction brake lining 16 against the brake disc 14 in addition to the force exerted by the actuating device 20, thus increasing the pressing the force of the two friction brake linings 16, 18 and therefore increasing the braking force. This effect is referred to as self-amplification. With the wedge 26 that is supported against the inclined surface 28 of the disc brake caliper 12, the disc brake 10 has a mechanical self-amplification device with a wedge mechanism. If the brake disc 14 is rotating in the opposite rotation direction, then the wedge mechanism produces a self-attenuation, i.e. a pressing force of the friction brake linings 16, 18 against the brake disc 14 and therefore a braking force of the disc brake 10 is less than it would be without the wedge mechanism.

FIGS. 2 to 6 show various possible arrangements of a self-amplifying electromechanical wheel brake 10 of the type shown in FIG. 1 in wheels 30, 32, 34, 36 of a motor vehicle that is otherwise not shown, in particular a passenger vehicle. The wheel brakes of the passenger vehicle do not absolutely have to have the design shown in a simplified, schematic fashion in FIG. 1; other brake designs are also known and possible. The vehicle brake system of the motor vehicle can also be embodied in the form of a hybrid brake system, i.e. it has for example two electromechanical wheel brakes 10 of the kind shown in FIG. 1 on one vehicle axle and, for example, conventional hydraulic wheel brakes on the other vehicle axle. In FIGS. 2 through 6, a forward travel direction of the motor vehicle is assumed to be toward the left and is indicated with an arrow 38. The self-amplification direction of the wheel brakes of the wheels 30, 32, 34, 36 is indicated with a triangle 40. The wheel brakes themselves are not shown in FIGS. 2 through 6.

In the vehicle brake system shown in FIG. 2, wheel brakes associated with a front axle 42 are self-amplifying in the forward travel direction and the wheel brakes associated with a rear axle 44 have a self-amplifying action in the reverse travel direction. The wheel brakes of the front axle 42, which must exert the most powerful braking force when braking during travel in the forward direction due to a weight distribution of the motor vehicle and a weight shift during braking, are therefore self-amplifying in the forward travel direction. Although the wheel brakes associated with the rear axle 44 have a self-attenuating action in the forward travel direction, their braking force is sufficient since the wheel brakes of the wheels 34, 36 of the rear axle 44 are only required to exert a significantly less powerful braking force. When traveling in the reverse direction, on the one hand, the speed is lower than when traveling in the forward direction and on the other hand, the dynamic axle load distribution reverses so that the braking force in the wheel brakes of the wheels 30, 32 of the front axle, which are self-attenuating when traveling in the reverse direction, is still sufficient.

In the vehicle brake system shown in FIG. 3, all four wheel brakes are self-amplifying when traveling in the forward direction. This permits a powerful braking force to be generated in all four vehicle wheels 30, 32, 34, 36 when traveling in the forward direction. Since the driving speed is lower when traveling in the reverse direction and since a less powerful braking force suffices, a sufficient braking of the motor vehicle can still be achieved with the four brakes that are self-attenuating in the reverse travel direction.

In the vehicle brake system shown in FIG. 4, the wheel brakes associated with the front axle 42 are self-amplifying in the forward travel direction. The wheel brakes associated with the rear axle 44 have self-amplification devices for both rotation directions of the vehicle wheels 34, 36 and therefore for both travel directions of the motor vehicle. The wheel brakes that are associated with the rear axle 44 and self-amplifying in both travel directions are symbolized in FIG. 4 by two triangles 46 pointing away from each other and joined at their bases. This embodiment of the vehicle brake system according to the present invention has the advantage that all four wheel brakes are self-amplifying in the forward travel direction, in which the most powerful braking force is required. When traveling in the reverse direction, the wheel brakes associated with rear axle 44 are self-amplifying. A disadvantage is the greater cost of the wheel brakes equipped with self-amplification devices for both rotation directions. To achieve this bidirectional action, the wheel brake 10 shown in FIG. 1 must have a second wedge 26 and a second inclined surface 28 whose inclination is oriented in the opposite direction from that of the wedge 26 and inclined surface 28 shown in the drawing.

In the vehicle brake system shown in FIG. 5, only the wheel brakes associated with the front axle 42 have a self-amplification device, which is effective in the forward travel direction. The wheel brakes associated with the rear axle 44 do not have any self-amplification device. The can be actuated electromechanically or for example also hydraulically or pneumatically.

In the vehicle brake system shown in FIG. 6, the wheel brakes associated with the front axle 42 have self-amplification devices for both rotation and travel directions. The wheel brakes associated with the rear axle 44 have a self-amplification device for only one rotation and travel direction; in the example shown, the self-amplification is effective in only the forward travel direction. The wheel brakes associated with the rear axle 44 can, however, also have a self-amplification device that is effective in only the reverse travel direction or can have no self-amplification device at all.

1-8. (canceled)

9. In a vehicle brake system having self-amplifying electromechanical wheel brakes, the improvement comprising wheel brakes associated with a front axle having a self-amplification that is effective in only the forward travel direction.

10. The vehicle brake system according to claim 9, further comprising wheel brakes associated with a rear axle having a self-amplification that is effective only in the reverse travel direction.

11. The vehicle brake system according to claim 9, further comprising wheel brakes associated with a rear axle having a self-amplification that is effective only in the forward travel direction.

12. The vehicle brake system according to claim 9, further comprising wheel brakes associated with a rear axle having self-amplifications that are effective in both travel directions.

13. The vehicle brake system according to claim 9, further comprising wheel brakes associated with a rear axle which have no self-amplification.

14. The vehicle brake system according to claim 9, wherein the wheel brakes comprise a mechanical self-amplification device.

15. The vehicle brake system according to claim 14, wherein the self-amplification device comprises a wedge mechanism.

16. In a vehicle brake system having self-amplifying electromechanical wheel brakes, the improvement wherein wheel brakes associated with a front axle have a self-amplification that is effective in both travel directions and wherein wheel brakes associated with a rear axle have a self-amplification that is effective in only one travel direction.
